(19) United States
(12) Patent Application Publication
(10) Pub. No.: US 2012/0116847 A1
(43) Pub. Date: May 10, 2012

(54) SYSTEM AND METHOD FOR MANAGING ELECTRIC PURCHASING STRATEGIES

(75) Inventor: John R. MARTORELLA, Woodmere, NY (US)

(73) Assignee: RELIABLE POWER ALTERNATIVES CORPORATION, Garden City, NY (US)

(21) Appl. No.: 12/942,542

(22) Filed: Nov. 9, 2010

(51) Int. Cl. G06Q 10/00

(52) U.S. Cl. 705/7.36

(57) ABSTRACT

Provide is a system and method for managing electric purchasing strategies. A processor receives electric pricing information, electric usage information, a plurality of input parameters, and generates electric purchasing strategies based on the electric pricing information, the electric usage information, and the plurality of input parameters; and a memory stores the electric pricing information, the electric usage information, the plurality of input parameters, and the electric purchasing strategies.

### BACKGROUND OF THE INVENTION

Electric power is used in all types of commercial, institutional and industrial operations. For example such operations can include large-scale lighting of commercial office buildings, running air conditioning units for institutional facilities, and powering machines to manufacture products in industrial facilities. The costs associated with the consumption of the amounts of electric power required to perform these operations can run into the hundreds of thousands of dollars and more. The slightest fluctuation in the price paid for the electric power can translate in great savings or additional costs to an organization owning such buildings.

### SUMMARY OF THE INVENTION

Accordingly, the present invention has been made to solve at least the above-mentioned problems occurring in the prior art, and an object of the present invention is to provide a system for managing electric purchasing strategies, comprising a processor for receiving electric pricing information, receiving electric usage information, receiving a plurality of input parameters, and generating electric purchasing strategies based on the electric pricing information, the electric usage information, and the plurality of input parameters; and a memory for storing the electric pricing information, storing the electric usage information, storing the plurality of input parameters, and storing the electric purchasing strategies.

It is a further object of the present invention to provide a method for managing electric purchasing strategies, comprising receiving by a processor electric pricing information and storing in a memory the electric pricing information; receiving by the processor electric usage information and storing in the memory the electric usage information; receiving by the processor a plurality of input parameters and storing in the memory the plurality of input parameters; and generating by the processor electric purchasing strategies based on the electric pricing information, the electric usage information, and the plurality of input parameters.

It is a further object of the present invention to provide a system for managing electric purchasing strategies, comprising a processor for electronically receiving on a periodic basis electric pricing information from at least one Regional Transmission Organization (RTO) or Independent System Operator (ISO), electronically importing electric usage information from an electric company selected to supply electric power for a building, electronically receiving information related to at least one commodity that influences electric pricing, receiving a plurality of input parameters, and generating electric purchasing strategies based on the electric pricing information, the electric usage information, and the plurality of input parameters, the electric purchasing strategies including at least one of an electric pricing strategy, an electric usage strategy, an electric cost analysis strategy, a hedge position strategy, a projection strategy, a futures pricing strategy, and a cross commodity strategy; and a memory for storing the electric pricing information, storing the electric usage information, storing the plurality of input parameters, storing the information related to at least one commodity, and storing the electric purchasing strategies.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a system for managing electric purchasing strategies according to an embodiment of the present invention;

FIG. 2 is a block diagram illustrating an energy management system of FIG. 1:

FIG. 3 is a block diagram illustrating data contained in a database of energy management system of FIG. 1:

FIG. 4 is a diagram illustrating various outputs generated by the energy management system of FIG. 1;

FIG. 5 is a diagram illustrating relations between data and outputs of the energy management system of FIG. 1: and

FIG. 6 is a flow chart illustrating a method for managing electric purchasing strategies according to an embodiment of the present invention.

### DETAILED DESCRIPTION OF THE INVENTION

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention rather unclear. Reference will now be made to the drawings in which the various elements of the present invention will be given numerical designations. In its present form the invention consists of several distinct elements. These elements when combined as described within will allow one of ordinary skill in the art to made and use the present invention.

In today's deregulated electric power markets, private power companies supply power to a power transmission grid. In North America, Regional Transmission Organizations (RTOs) and/or Independent System Operators (ISOs) (referred to herein as simply RTOs) administer the transmission grid on a regional or zone basis. The power companies contract with the RTOs to supply electric power to the grid based on demand. The demand can vary over time and location, and can change based on factors such as demand needs, supply amounts, weather conditions, etc. Demand can actually vary from hour-to-hour and minute-to-minute according to these and other factors.

The deregulation of the electric power market has also allowed consumers to purchase electric power from any number of private power companies. Thus, company X can contract with power company A to supply power to company X. Power company A supplies power to the grid, and company X uses power from the grid. Power company A charges company X for the power company X uses. This is typically referred to as a spot market or market price purchase.

Alternatively, power company A may permit company X to prepay for electricity at a set contract price. Company X can approach an electric energy broker representing power company A and request that power company A enter into a contract to sell company X electricity for a specific period (e.g. May 2012) at a set price. This is typically referred to as a futures market purchase. In this scenario, company X can save money if the contract price is actually less than the market price for the set period, but could also result in paying more for the electricity if the contract price is greater than the market price.

The strategies of selecting an electric company and/or determining whether to purchase electricity in the spot market or on the futures market must be managed closely in order for the organization to realize savings. If managed correctly, these electric purchasing strategies can result in great savings to the organization; if managed poorly, disaster can result. Managing electric purchasing strategies for commercial, institutional and industrial consumers requires analysis of all aspects of buying parameters by integrating detailed usage, cost and futures commodity data. In order to fully manage electric purchasing strategies an individual is required to trend, track, and project future buying strategies.

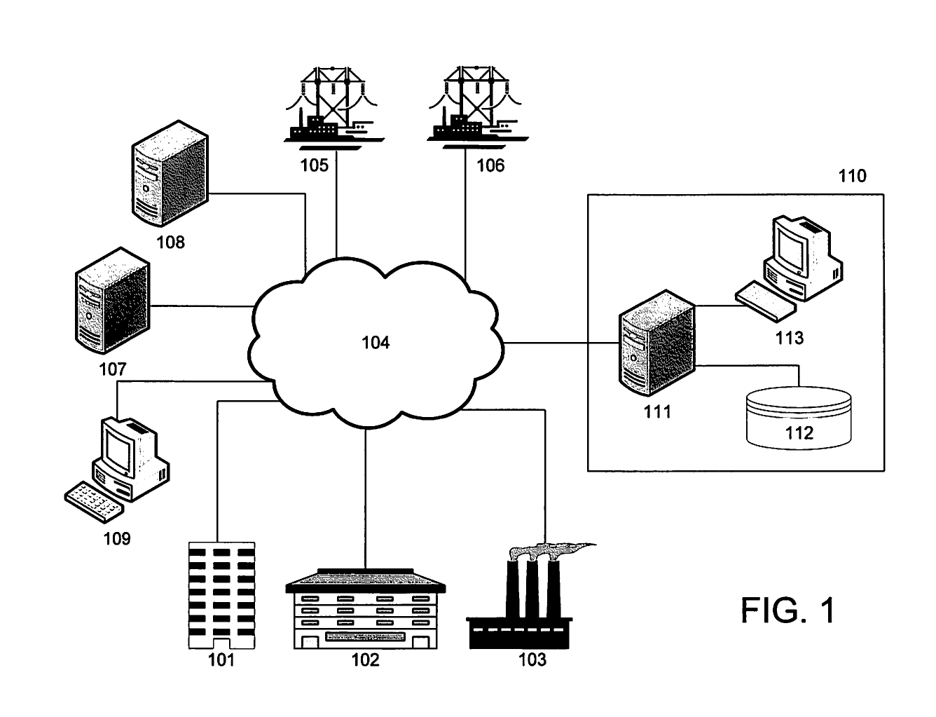

FIG. 1 is a diagram illustrating a system for managing electric purchasing strategies according to an embodiment of the present invention.

Shown in FIG. 1 are commercial building 101, institutional building 102 and industrial building 103, each connected to a network 104. Network 104 can be a Local Area Network (LAN), a Wide Area Network (WAN), the Internet, etc. Also shown connected to network 104 are power company 105 and power company 106. RTOs are also shown connected to network 104 in FIG. 1 and are illustrated as processors 107 and 108. User terminal 109 is shown connected to network 104. Energy management system 110 is shown connected to network 104.

Energy management system 110 can include processor 111, database (i.e. memory) 112 and terminal 113. Energy management system 110 can collect power usage data from buildings 101-103. Power company 105-106 can collect power usage data from buildings 101-103 either manually or remotely if buildings 101-103 are equipped with electronic power meters (not shown). Energy management system 110 can collect the power usage data from power company 105-106, or, if buildings 101-103 are equipped with electronic power meters (not shown), directly from buildings 101-103: other methods of collecting the power usage data are contemplated. Energy management system 110 can collect electric pricing from RTOs 108-109. The electric pricing is collected from the RTOs on a regular basis, which can vary depending on how closely the electric prices are to be tracked. For example, the electric prices can be collected from the RTOs daily, hourly, every minute, etc. Energy management system 110 can store the power usage data and electric pricing in database 112. A user (not shown) can access processor 111 and database 112 through terminal 113 or remotely through network 104 from terminal 109. Energy management system 110 can manage electric purchasing strategies for buildings 101-103 through the analysis of all aspects of buying parameters by integrating detailed usage, cost and futures commodity data. In order to fully manage electric purchasing strategies energy management system 110 can trend, track, and project future buying strategies.

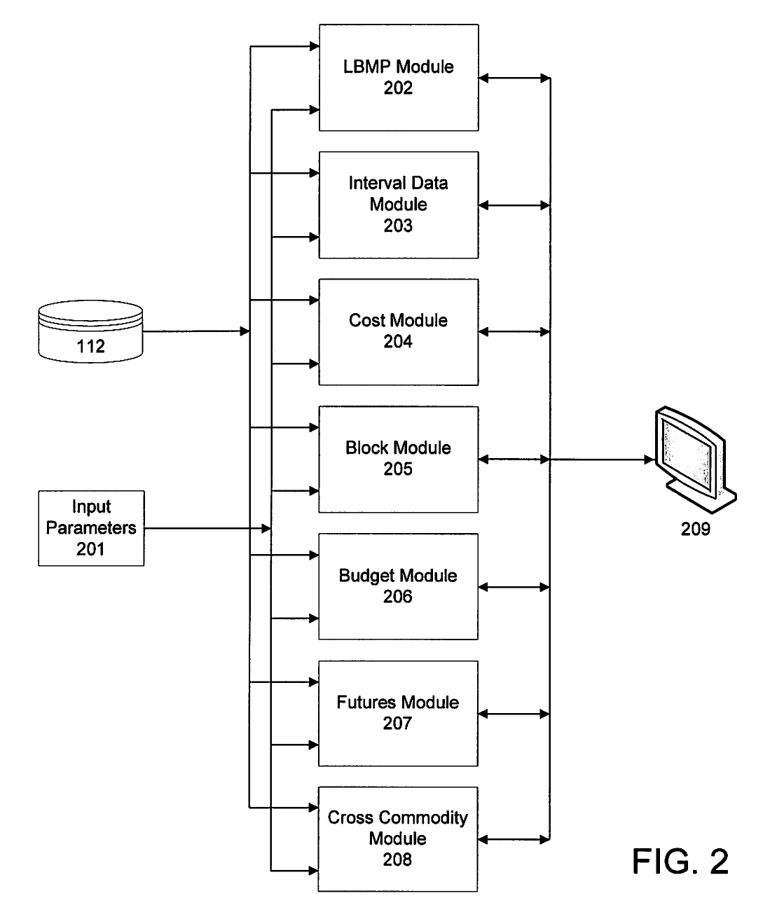

FIG. 2 is a block diagram illustrating an energy management system of FIG. 1.

As shown in FIG. 2, included in energy management system 110 are Location Based Marginal Pricing (LBMP) module 202, Interval Data Module 203, Cost Module 204, Block Module 205, Budget Module 206, Futures Module 207, and Cross Commodity Module 208. Also shown in FIG. 2 are database 112, input parameters 201, and display 209. Input parameters 201 can be received from a user (not shown) through an input device (e.g. a keyboard or mouse through text boxes or check boxes provided on a display) and can include, for example, a selection of a particular RTO(s), high/low electric prices, dates, date ranges, cross commodity information, etc. Although display 209 is shown, the output of processor 111 can also be directed to a printer (not shown).

LBMP Module 202 receives data from database 112 and input parameters 201, and can output for display on display 209 electric pricing data. LBMP Module 202 can output spot electric pricing for all regions based on the electric pricing received from RTOs 107-108 and stored in database 112. In addition, LBMP Module 202 can trend historical pricing by hour, day, week or month for any primary date range chosen as input parameters 201 and output other periods for comparison purposes.

Interval Data Module 203 receives data from database 112 and input parameters 201, and can output for display on display 209 usage information. Interval Data Module 203 can display actual hourly usage of a particular building (e.g. building 101) and/or can aggregate usage information for buildings owned by a single organization (e.g. buildings 101-103). Input parameters 201 can include a selection of buildings, dates, data ranges, and/or projected periods. Projected periods can be processed using historical hourly interval data usage. Interval Data Module 203 can precisely develop a strategy of buying blocks of electricity to hedge positions for accounts being tracked.

Cost Module 204 receives data from database 112 and input parameters 201, and can output for display on display 209 cost analysis information. Cost Module 204 can output to display 209 past economic performance and can process detailed invoice checks for power actually bought. In addition to receiving data from database 112 and input parameters 201, Cost Module 204 can receive output from other modules to create layered reports. For example, Cost Module 204 can receive output from Interval Data Module 203 to output an hourly usage, or receive output from LBMP Module 202 to output an hourly price of power, and/or receive output from Block Module 205 for information on the hedged or purchased blocks of power that were bought on the forward/futures market. Cost Module 204 can integrate all these parameters on an hour-by-hour basis and produce a report that details a cost over a date range on a unit basis as well as on a total basis. In effect. Cost Module 204 can be used for checking invoices that are generated by vendors supplying power to a consumer.

Block Module 205 receives data from database 112 and input parameters 201, and can output for display on display 209 hedge position information. Block Module 205 can output information regarding hedged positions over a specified date range (input as input parameters 201) and draws on the usage data for a customer. Block Module 205 can illustrate all individual purchased blocks (hedges) on a calendar month basis for on-peak and off-peak positions. Block Module 205 can also output hedged percentages, blended prices for on-peak and off-peak for an entire month. Block Module 205 can also output the aggregate positions for specified and blended prices broken down by on-peak, off-peak and for an entire period. The block purchases can be input as input parameters 201 and stored in database 112 at the time the blocks are purchased. Block Module 205 can also receive input from Interval Data Module 203 in order to calculate percentage hedged positions for monthly on-peak, off-peak and full month values. Additionally. Block Module 205 can also receive daily market pricing data for wholesale blocks on a monthly basis for on-peak and off-peak and output for display these values in order for a consumer to compare a blended price to a current market indicator price.

Budget Module 206 receives data from database 112 and input parameters 201, and can output for display on display 209 projection information. Budget Module 206 can integrate output from other modules to create detailed performance “look back” or forward looking projections. Budget Module 206 can complete an hour-by-hour calculation for an entire period set by a user through input parameters 201, from one month to any number of months. Budget Module 206 can incorporate all existing block data, hourly usage data, hourly cost data and many other input parameters 201 to generate an output showing monthly periods in great detail. Budget Module 206 can also make use of input parameters 201 (e.g. historic cost data) to show year on year comparisons on a monthly basis. Budget Module 206 can also perform many “what-ifs” scenarios on any number of dependent input parameters 201.

Futures Module 207 receives data from database 112 and input parameters 201, and can output for display on display 209 future pricing information. Futures Module 207 can output futures pricing for both on and off-peak periods for many of the traded “electric hubs” in a region.

Cross Commodity Module 208 receives data from database 112 and input parameters 201, and can output for display on display 209 information cross-referencing natural gas and electric pricing. Although natural gas is referred to herein as the cross commodity, other commodities are contemplated, for example, oil, coal, wind, and/or solar. Energy management system 110 collects cross commodity information and stores the cross commodity information in database 112. Cross Commodity Module 208 can trend, over an equivalent period of time, the relationship among futures prices and spot prices for natural gas and electricity. Cross Commodity Module 208 can output valuable information for evaluating purchases at any given time and instantly viewing trends, minimum price points and seasonal variations. Cross Commodity Module 208 can output individual months as well as specify certain “strip” prices, based on various input parameters 201.

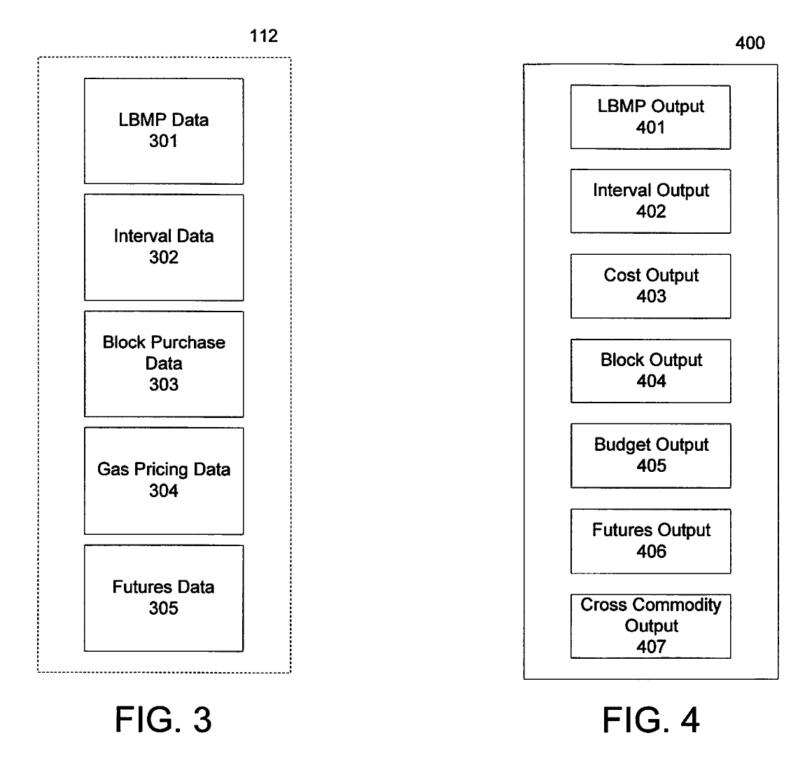

FIG. 3 is a block diagram illustrating data contained in a database of energy management system of FIG. 1. The data stored in database 112 can be classified into five categories: LBMP Data 301. Interval Data 302. Block Purchase Data 303. Gas Pricing Data 304, and Futures Data 305. The categories are organizational in nature and are not structural memory storage locations. Along with input parameters 201. Data 301-305 is used by Modules 202-208 to generate the output for display and/or printing. The various outputs generated by Modules 202-208 are illustrated in FIG. 4.

FIG. 4 is a diagram illustrating various outputs generated by the energy management system of FIG. 1. As explained above. Modules 202-208 can utilize Data 301-305 and input parameters 201 to generate various outputs. Some of these outputs are as follows: LBMP Output 401, Interval Output 402, Cost Output 403, Block Output 404, Budget Output 405, Futures Output 406, and Cross Commodity Output 407: other outputs are contemplated. These outputs will be further described in detail below.

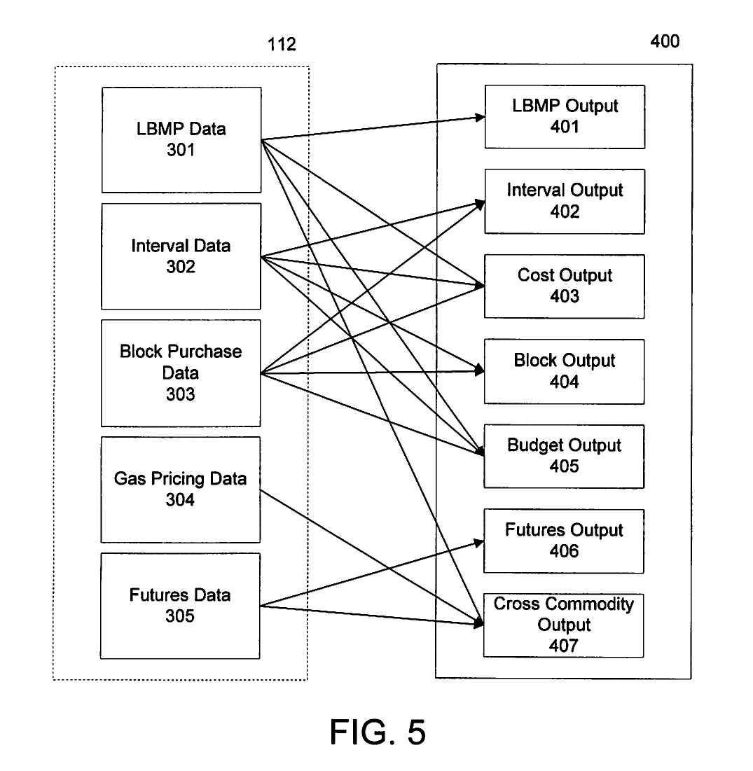

FIG. 5 is a diagram illustrating relations between data and outputs of the energy management system of FIG. 1. Not shown in FIG. 5 are input parameters 201 that are used along with Data 301-305 to generate Outputs 401-407. LBMP Data 301 can be used to generate LBMP Output 401, Cost Output 403, Budget Output 405, and Cross Commodity Output 407. Interval Data 302 can be used to generate Interval Output 402, Cost Output 403. Block Output 404, and Budget Output 405. Block Purchase Data 303 can be used to generate Interval Output 402. Cost Output 403, Block Output 404, and Budget Output 405. Gas Pricing Data 304 can be used to generate Cross Commodity Output 407. Futures Data 305 can be used to generate Futures Output 406 and Cross Commodity Output 407.

As previously stated, the various outputs of the energy management system are based on Data 301-305 contained in database 112 and input parameters 201. The generation of the outputs of Modules 202-208 will now be described in detail.

When displayed, LBMP Output 401 can illustrate hourly, day ahead, or real time LBMP for RTOs throughout respective regions. Table 1 lists the information (i.e. data and/or input parameters) LBMP Module 202 can use to generate LBMP Output 401.

TABLE 1

| Inputs | Description |
|---|---|
| Start Date | Date from which to start collecting data for |
| | output |
| End Date | Data is collected up until the last hour on this |
| | day |
| Scale | Scale to use for the x-axis (e.g. time)—hourly, |
| | daily, weekly, or monthly |
| RTO | Regional Transmission Organization; can be |
| | selected from multiple RTOs |
| Zone | Zone with a particular ISO (e.g. Zone J (New |
| | York City), etc . . . ) |
| LBMP Type | LBMP Market to be displayed: Day Ahead, Real |
| | Time, or Both |
| Period 2 | Allows the output of a second graph and |
| | summary along side a primary graph; Start Date, |
| | End Date, Block Information, and Scale |
| | information can be specified |
| Peak or Off | Input for specifying block pricing information; |
| Peak Block | displayed as a separate line on displayed output |
| Peak, Off Peak | Allow the output to include only particular hours |
| Weekend, Off Peak | within the start and end dates specified |
| Weekday, Holiday | |

As shown in Table 1, information input to LBMP Module 202 can include a start date, an end date, a scale (hourly, daily, weekly, or monthly), an RTO, a zone, and a type (Day Ahead or Real Time or both—where applicable). In addition, the information can include peak and off peak block information, peak hours, off peak weekday, off peak weekend, or off peak holidays, a second period with it's own date range, block and scale information, etc. The hourly LBMP data can be obtained directly from each RTO. The display of LBMP Output 401 can include all data that falls under the criteria specified as input parameters 201, and points can be ‘rolled-over’ by a mouse pointer to specify detailed information on that specific data point. In addition, summary data can be displayed to identify average pricing values for a specific time period. LBMP Output 401 can be used to display pricing data in dollars per kilowatt hour ($/kWhr). Daily charts, weekly charts or monthly charts can be displayed.

LBMP Output 401 is generated using the following algorithm(s):
y-axis=LBMP_UNIT (Cost of power in $/kWhr for a specific RTO zone) or BLOCK_UNIT (Block cost in $/kWhr); and
x-axis=TIME (Time—default is by hour, but can be daily, weekly, or monthly);
On Peak=average $/kWhr for peak hours;
Off Peak=average $/kWhr for off peak hours (including holidays and weekends);
Aggregated=average $/kWhr for all hours.

When displayed. Interval Output 402 plots hourly usage data for an account or an aggregate of accounts. Table 2 lists the information (i.e. data and/or input parameters) Interval Module 203 can use to generate Interval Output 402.

TABLE 2

| Inputs | Description |
|---|---|
| Start Date | Date from which to start collecting data for |
| | output |
| End Date | Data is collected up until the last hour on this |
| | day |
| RTO | Regional Transmission Organization; can be |
| | selected from multiple RTOs |
| Zone | Zone with a particular ISO (e.g. Zone J (New |
| | York City), etc . . . ) |
| LBMP Type | LBMP Market to be displayed: Day Ahead, Real |
| | Time, or Both |
| Period 2 | Allows the display of a second graph and |
| | summary along side the primary graph: Start |
| | Date, End Date, Block Information, and Scale |
| | information can be selected |
| Peak or Off | Input for specifying block size information (e.g. |
| Peak Block | kw); displayed as a separate line on displayed |
| | output (e.g. “Use Block Purchase Data”: entered |
| | block numbers are added to existing block |
| | purchase values) |
| Peak, Off Peak | Allow the output to include particular hours |
| Weekend, Off Peak | within the start and end dates specified |
| Weekday, Holiday | |
| Use Block | Can be used to display distinct accounts and |
| Purchase Data | purchase contract information |
| Target, Strike, | Used to determine types of blocks to output |
| Actual | |
| Account Number | Used to display account numbers available; can |
| | be filtered by LBMP zones and contracts if “Use |
| | Block Purchase Data” is used |
| Show All | Enables the output of all accounts regardless of |
| accounts for | which RTO and/or LBMP is selected; can assist |
| all RTOs | in an analysis across different LBMP zones |

Interval Output 402 includes hourly data collected from an electric company and/or directly from a customer. The block purchase data can be entered manually or automatically using an electronic importing function. Electronic importing functions are well known; for example, many banking institutions permit the download and import of account statement data for a banking institution into a customers banking program.

The Interval Output 402 can be used to chart electric power usage in kWh on the y-axis for each hour on the x-axis. The Interval Output 402 can be displayed as a line graph along with block purchase (size) information. A summary section can be displayed showing usage totals for an account or aggregate of accounts specified, plus load factor and block information.

Interval Output 402 is generated using the following algorithm(s):
y-axis=USAGE (Usage in kWh for one or many accounts) or BLOCK_SIZE (block purchase size for one or many accounts) (Note: This cost can be filtered by: Market—Real Time or Day Ahead; or, Time of day—Peak or Off Peak or Holiday or Weekend)
x-axis=TIME (Time—in hours)

Hedge
Peak=sum of block usage during peak hours (BLOCK_P_USAGE);
Offpeak=sum of block usage during off peak hours (BLOCK_OP_USAGE);
Total=sum of total block usage (BLOCK_USAGE):

Overrage
Peak=if (Block>Usage) then sum of (block)-(usage) during peak hours (OVERAGE_P_USAGE);
Off Peak=if (Block>Usage) then sum of (block)-(usage) during off peak hours (OVERAGE_OP_USAGE);
Total=if (Block>Usage) then sum of (block)-(usage) during all hours (OVERAGE_USAGE);

Aggegate
Peak=sum of peak usage (usage that is the greater of block or account usage) (USAGE_P):
Off Peak=sum of off peak usage (usage that is the greater of block or account usage) (USAGE_OP):
Total Peak=sum of all usage (usage that is the greater of block or account usage);

Load Factor
Peak=(USAGE_P)/((Maximum Peak Usage for one hour)*(Total Peak Hours));
Off Peak=(USAGE_OP)/((Maximum Off Peak Usage for one hour)*(Total Off Peak Hours));
Total=(USAGE)/(Maximum Usage for one hour)*(Total Hours)).

When displayed, Cost Output 403 plots hourly usage data for an account or an aggregate of accounts. Table 3 lists the information (i.e. data and/or input parameters) Cost Module 204 can use to generate Cost Output 403.

TABLE 3

| Inputs | Description |
|---|---|
| Start Date | Date from which to start collecting data for |
| | output |
| End Date | Data is collected up until the last hour on this |
| | day |
| RTO | Regional Transmission Organization; can be |
| | selected from multiple RTOs |
| Zone | Zone with a particular ISO (e.g. Zone J (New |
| | York City), etc . . . ) |
| LBMP Type | LBMP Market to be displayed: Day Ahead, Real |
| | Time, or Market Price; Market Price uses the |
| | market stored a database (e.g. to specify usage |
| | of real-time for one month, but day ahead for |
| | others) |
| Period 2 | Allows the output of a second graph and |
| | summary along side a primary graph; Start Date. |
| | End Date, Block Information, and Scale |
| | information can be specified |
| Peak or Off | Input for specifying block size information; can |
| Peak Block | be displayed as a separate line on a graph (e.g. if |
| | “Use Block Purchase Data” used, then entered |
| | block numbers are added to existing block |
| | purchase values) |
| Peak, Off Peak | Allow the output to include only particular hours |
| Weekend, Off Peak | within the start and end date specified |
| Weekday, Holiday | |
| Use Block | Can be used to display distinct accounts and |
| Purchase Data | purchase contract information |
| Target, Strike, | Used to determine types of blocks to output and |
| Actual | display |
| Account Number | Used to output and display accounts numbers; |
| | can be filtered by LBMP zones and contracts if |
| | “Use Block Purchase Data” is used |
| Show All | Enables the output of all accounts regardless of |
| accounts for | which RTO and/or LBMP is selected; can assist |
| all RTOs | in an analysis across different LBMP zones |
| Retail Adder | Retail Adder for contract; can be pre-populated |
| | from a contract database |
| Line Loss | Line loss percentage for contract; can be pre- |
| | populated from a contract database |
| Portfolio View | Shows data as a unit cost line chart |

Cost Output 403 can be used to plot hourly costs based on LBMP, hourly interval data and/or block cost for specified accounts. The Cost Output 403 can utilize interval data. LBMP data and/or block purchase data to calculate an energy cost during a specified time period. Line losses and retail adders can also be factored in based on the information provided as input parameters 201.

An example of a cost chart based on the Cost Output 403 can display cost based on usage and a marginal price for each hour. An area between a block purchase and cost values indicates an unhedged portion of the cost. In a portfolio view, a unit cost can be displayed as a line chart. A summary below a chart can be displayed to show average unit cost, and/or total cost aggregated across a time period for peak and off peak hours. Retail adder, line loss and/or overage can be indicated where applicable. Usage information can also be displayed below cost information, providing an indication of how much of the usage was not hedged and/or was hedged.

Cost Output 403 is generated using the following algorithm(s):
y-axis (Stacked Area Chart)=(UNHEDGED_UNIT*USAGE) (Unhedged Unit Cost*Usage in kWh for one or many accounts) and/or (BLOCK_UNIT*BLOCK_SIZE) (block cost*block purchase size for one or many accounts) (Note: This cost can be filtered by: Market—Real Time or Day Ahead, or Time of day—Peak or Off Peak or Holiday or Weekend)
x-axis=Time (in hours)

Block
weighted AVG unit cost of blocks purchase for Peak and Off Peak hours (BLOCK_P_UNIT and BLOCK_OP_UNIT);
SUM of cost over peak and off peak hours (BLOCK_P_COST and BLOCK_OP_COST);

Unhedged
unit cost of unhedged portion of usage for Peak and Off Peak hours (UNHEDGED_P_UNIT and UNHEDGED_OP_UNIT);
SUM of unhedged cost over Peak and Off Peak hours (UNHEDGED_P_COST and UNHEDGED_OP_COST);

Cost of Energy
weighted average unit cost of block purchases and unhedged (ENERGY_UNIT);
if TIME contains future dates: market price (day ahead or real time) cost over all hours;
SUM of total cost of energy over all hours (ENERGY_COST);

Retail Adder
retail adder ($/kWh) for all hours (RETAIL_ADDER);
SUM of retail adder cost over all hours (RETAIL_ADDER_COST);

Line Loss (for Peak and Off Peak Hours)
unit cost calculated by: [((Real Time Cost in $/kWh)*SUM(Usage)*(Line Loss/100))/Total hours](LINE_LOSS);
Line Loss Cost: [((Real Time Cost in $/kWh)*SUM(Usage)*(Line Loss/100))](LINE_LOSS_COST);

Overrage (for Peak and Off Peak Only if Block Size>Usage)
unit cost calculation: [((Block kWh)-(Usage kWh))*(Real Time Cost)]/Total Hours (OVERRAGE_UNIT);
Overage Cost::[((Block kWh)-(Usage kWh))*(Real Time Cost)](OVERAGE_COST);

Blended Cost
Weighted Average of (Unit Cost of Energy+Retail Adder+Line Loss+Overrage) (TOTAL_UNIT_PRETAX);
SUM of (Cost of Energy+Retail Adder+Line Loss+Overrage) (TOTAL_COST_PRETAX);

Usage Section (Peak, Off Peak and Total Values for)
Block Usage (BLOCK_USAGE);
Unhedged Usage (UNHEDGED_USAGE);
Overrage Usage (OVERAGE_USAGE);
Historical Usage;
All Usage (USAGE).

Market Purchase History displays all changes in positions between real time and day ahead pricing for specific time periods.

When displayed. Block Output 404 displays hedged positions for blocks purchased for accounts in a specified date range including percentage hedged in on and off peak periods. Table 4 lists the information (i.e. data and/or input parameters) Block Module 205 can use to generate Block Output 404.

TABLE 4

| Inputs | Description |
|---|---|
| Start Date | Date from which to start collecting data for |
| | report |
| End Date | Data is collected up until the last hour on this |
| | day |
| RTO | Regional Transmission Organization; can be |
| | selected from multiple RTOs |
| Zone | Zone with a particular ISO (e.g. Zone J (New |
| | York City), etc . . . ) |
| Block Type | Target, Strike or Actual block purchases |
| Period 2 | Allows the output of a second graph and |
| | summary along side a primary graph; Start Date, |
| | End Date, Block Information, and Scale |
| | information can be specified |
| Contract No | Can be used to select a contract for which block |
| | purchase information can be displayed |

Block Output 404 can include information from block purchase data. The block purchase data can be entered manually or automatically using an electronic importing function. Electronic importing functions are well known: for example, many banking institutions permit the download and import of account statement data for a banking institution into a customers banking program.

Block types can be defined into target block purchase, strike block purchase, and/or actual block purchase. A Target Block is a hypothetical block purchase that is entered into the system: a Target Block can be used for budget analysis and to compare different buying strategies and portfolio management scenarios. A Strike Block Purchase is a block purchase which is executed upon purchase price reaching less than or equal to a price specified in the contract, prior to the expiration of the contract. An Actual Block Purchase is a fully executed block purchase with a signed contract.

The Block Output 404 can be used to display block purchase (size) information for each calendar month in the form of a bar chart. Peak and off peak purchases can be displayed separately. A summary can display total block purchases for each month along with price information, followed by detailed information on each block purchase for corresponding months. Hedge estimates can also be provided on historical usage.

Block Output 404 is generated using the following algorithm(s):
y-axis=SUM of the size of blocks purchased for a given month (BLOCK_SIZE);
x-axis=TIME (in months);
Market Price=Futures Contract Price as of date indicated for the month specified;
Price (Avg)=Average block purchase price, on and off peak. (BLOCK_P_UNIT and BLOCK_OP_UNIT):
ATC Price=Average block purchase price over all hours (BLOCK_UNIT):
Block Size=SUM of block purchases for peak and off peak hours (BLOCK_SIZE);
Total Hedged=SUM(BLOCK_SIZE*[Peak, Off Peak, and All]HOURS) this (display also includes a value indicated the percentage of total usage that is hedged by this block purchase. (BLOCK_USAGE);
Usage (kWh)=total interval usage for accounts specified (USAGE):
Actual Purchases section: displays the size (% hedged), price, signed date for each block purchase by month.

When displayed, Budget Output 405 can be used to display actual past performance or use to project costs based on every variable that effects electric prices. Table 5 lists the information (i.e. data and/or input parameters) Budget Module 206 can use to generate Budget Output 405.

TABLE 5

| Inputs | Description |
|---|---|
| Start Date | Start Date is entered as a month and year |
| End Date | End Date is entered as a month and year; a input |
| | parameters screen can add or delete rows |
| | depending on the number of months between the |
| | start and end dates |
| RTO | Regional Transmission Organization; can be |
| | selected from multiple RTOs |
| Location | Select a location from available LBMP zones for |
| | a particular RTO |
| Type | Real Time or Day Ahead; defines a type of |
| | market on which to base the budget output |
| Include Block | Used to define the block purchase information |
| Purchase | will be included in output calculations |
| Contract | Selection of a particular contract can be made |
| Account Number | Selection of account numbers for a particular |
| | contract |
| Block Prices | Pricing and size information can be input for |
| | both peak and off peak hours during each period |
| | of the budget output |
| Retail Adder | Retail adder values can be input for each period |
| | of the output |
| Line Loss Factor | Line loss values can be input for each period of |
| | the output |
| LBMP % increase | Percent increase for both peak and off peak |
| vs last year | hours on the prior years LBMP values can be |
| | input for each period of the output |
| Local Distribution | LDC delivery cost can be entered for each |
| Company (LDC) | period of the output |
| Delivery Costs | |
| Prior Year | Prior year cost and LDC delivery cost can be |
| | entered for each period of the output |

Budget Output 405 is similar to Cost Output 403 in that both include LBMP data, interval data and block purchase data in addition to information supplied as input parameters 201.

Budget Output 405 is generated using the following algorithm(s) contained in Table 5A: [The table format has been slightly modified. Please confirm that the modifications are correct.]

TABLE 5A

| | | |
|---|---|---|
| VALUE | DESCRIPTION | DETAILS |

Usage based on: [hist(I, L)]
Current or Historical (-Years Interval, -Years LBMP)

| | | |
|---|---|---|
| USAGE_P | On Peak Usage | Total Peak Usage for the month |
| USAGE_OP | Off Peak Usage | Total Off Peak Usage for the month |
| USAGE | Total Usage | (USAGE_P) + (USAGE_OP) |
| DEMAND | Peak Demand | 1405.125 [Should this value be listed |
| | | as a number?] |
| LINE_LOSS | Line Loss Factor | Entry value as percent |

Unit Cost Component ($/kWh)
Type

| | | |
|---|---|---|
| BLOCK_P_UNIT | Block Cost (Peak) | BLOCK_P_COST/USAGE_P |
| BLOCK_OP_UNIT | Block Cost (Off Peak) | BLOCK_OP_COST/USAGE_OP |
| UNHEDGED_P_UNIT | Unhedged Load (Peak) | UNHEDGED_P_COST/USAGE_P |
| UNHEDGED_OP_UNIT | Unhedged Load (Off | UNHEDGED_OP_COST/USAGE_OP |
| | Peak) | |
| ENERGY_UNIT | Blended Cost of Energy | (ENERGY_COST)/ |
| | | (TOTAL_HOURS) |
| LINE_LOSS_P_UNIT | Line Loss (Peak) | LINE_LOSS_P_COST/USAGE_P |
| LINE_LOSS_OP_UNIT | Line Loss (Off Peak) | LINE_LOSS_OP_COST/USAGE_OP |
| RETAIL_ADDER | Retail Adder | RETAIL_ADDER_COST/USAGE |
| OVERAGE_P_UNIT | Overage (Peak) | OVERAGE_P_COST/USAGE_P |
| OVERAGE_OP_UNIT | Overage (Off Peak) | OVERAGE_OP_COST/USAGE_OP |
| TOTAL_UNIT | Total Unit Cost (pre-tax) | TOTAL_COST_PRETAX/USAGE |

Total Spend ($s)

| | | |
|---|---|---|
| BLOCK_P_COST | Block Cost (Peak) | (BLOCK_P_UNIT)*(BLOCK_P_USAGE) |
| BLOCK_OP_COST | Block Cost (Off Peak) | (BLOCK_OP_UNIT)* |
| | | (BLOCK_OP_USAGE) |
| UNHEDGED_P_COST | Unhedged Load (Peak) | (UNHEDGED_P_UNIT)* |
| | | (UNHEDGED_P_USAGE) |
| UNHEDGED_OP_COST | Unhedged Load (Off | (UNHEDGED_OP_UNIT)* |
| | Peak) | (UNHEDGED_OP_USAGE) |
| ENERGY_COST | Blended Cost of Energy | [(BLOCK_P_COST) + |
| | | (BLOCK_OP_COST) + |
| | | (UNHEDGED_P_COST) + |
| | | (UNHEDGE_OP_COST)] |
| LINE_LOSS_P_COST | Line Loss (Peak) | (USAGE_P*LINE_LOSS_PERC*RT_{—} |
| | | UNIT) |
| LINE_LOSS_OP_COST | Line Loss (Off Peak) | (USAGE_OP*LINE_LOSS_PERC*RT_{—} |
| | | UNIT) |
| RETAIL_ADDER_COST | Retail Adder | (RETAIL_ADDER)*(TOTAL_USAGE) |
| OVERAGE_P_COST | Overage (Peak) | [(BLOCK_P_USAGE) − |
| | | (UNHEDGED_P_USAGE)]* |
| | | (OVERAGE_P_UNIT) |
| OVERAGE_OP_COST | Overage (Off Peak) | [(BLOCK_OP_USAGE) − |
| | | (UNHEDGED_OP_USAGE)]* |
| | | (OVERAGE_OP_UNIT) |
| TOTAL_COST_PRETAX | Monthly Projected Spend | (ENERGY_COST) + (LINE_LOSS_P_{—} |
| | pre-tax | COST) + (LINE_LOSS_OP_COST) + |
| | | (RETAIL_ADDER_COST) − |
| | | (OVERAGE_P_COST + OVERAGE_{—} |
| | | OP_COST) |
| SALES_TAX_COST | Sales Tax | TOTAL_COST_PRETAX |
| | ({SALES_TAX_RATE}) | *SALES_TAX_RATE |
| RT_COST | RT({RECEIPTS | TOTAL_COST_PRETAX |
| | TAX_RATE}) | *RECEIPTS_TAX_RATE |
| TOTAL_COST | Total Monthly Spend | TOTAL_COST_PRETAX + SALES_{—} |
| | | TAX_COST + RT_COST |
| [Are there values for the | Delivery Cost Projected | |
| delivery cost projected?] | | |

Hedging Strategy

| | | |
|---|---|---|
| BLOCK_P_SIZE | On Peak Block (kW) | |
| BLOCK_P_USAGE | On Peak Block (kWh) | (BLOCK_P_SIZE)*(PEAK_HOURS) |
| BLOCK_OP_SIZE | Off Peak Block (kW) | |
| BLOCK_OP_USAGE | Off Peak Block (kWh) | (BLOCK_OP_SIZE)*(OFF_PEAK_{—} |
| | | HOURS) |
| HEDGE_P_PERC | % Hedged On Peak | BLOCK_P_USAGE/USAGE_P |
| HEDGE_OP_PERC | % Hedged Off Peak | BLOCK_OP_USAGE/USAGE_OP |
| [Please provide data for | | |
| remaining values below.] | | |
| | Prior Year Commodity | |
| | Costs | |
| | Total Prior Year | |
| | Commodity | |
| | Prior Year LDC Delivery | |
| | Costs | |
| | Total Prior Year Spend | |
| | % Inc Commodity Unit | |
| | Cost | |
| | % Inc Commodity (Year | |
| | on Year) | |
| | % Inc Delivery (Year on | |
| | Year) | |
| | % Inc Total Spend (Year | 48 |
| | on Year) | |

When displayed, Futures Output 406 can be used to display prices for electric futures contracts. Table 6 lists the information (i.e. data and/or input parameters) Futures Module 207 can use to generate Futures Output 406.

TABLE 6

| Inputs | Description |
|---|---|
| Peak and Off Peak | Identifies whether peak or off peak prices are |
| | selected |
| Futures electric Hub | List of hubs for which futures contract pricing |
| | data is collected |
| Include Historical | Used to include yearly averages of LBMP |
| LBMP | pricing for months displayed using the Futures |
| | Output |
| Dates | Input parameters that represent dates for contract |
| | pricing for a specific hub |

Futures Output 406 can be used to display data retrieved from various sources that encompass futures contract pricing for electric hubs. Futures Output 406 can be used to display pricing for each (monthly) futures contract, on each particular date chose, as a line graph.

Futures Output 406 is generated using the following algorithm(s):

y-axis=Unit price for futures contracts for the dates specified; and

x-axis=TIME (Month/Year).

When displayed, Cross Commodity Output 407 can be used to display comparison charts among different commodities. Table 7 lists the information (i.e. data and/or input parameters) Cross Commodity Module 208 can use to generate Cross Commodity Output 407.

TABLE 7

| Inputs | Description |
|---|---|
| Peak Only | Specifies if only peak data should be used in the |
| | output calculations; weekends and off peak |
| | hours can be excluded |
| Chart Type | Specifies if the output when displayed should be |
| | used to display a “line chart” or a “bar chart” |
| Start Date | Date from which to start collecting data for |
| | report |
| End Date | Data is collected up until the last hour on this |
| | day |
| Scale | Used to specify scale: daily, weekly, or monthly |
| Include LBMP | Output used to display all LBMP specific |
| | parameters, and LBMP data will be included |
| RTO | Regional Transmission Organization; can be |
| | selected from multiple RTOs |
| Zone | Zone with a particular ISO (e.g. Zone J (New |
| | York City), etc . . . ) |
| LBMP Type | LBMP Market that can be displayed: Day |
| | Ahead, Real Time, or Both |
| Blend | Used to specify percentage blends of Day ahead |
| | or Real-time values |
| Include Futures Data | All futures specific parameters will display and |
| | futures data will be included in the output |
| Futures Electric Hub | Selection of futures electric hubs for which data |
| | is available |
| Futures Month | Month of futures contract to include pricing |
| | trends on |
| Futures Year | Year of futures contract to include pricing trends |
| | on |
| Include Gas Data | All gas specific parameters will display and gas |
| | data will be included |
| Gas Hub | Selection of a gas hub for which to include |
| | pricing data |

Cross Commodity Output 407 can include futures pricing data, gas hub data, and LBMP data. As explained above, other commodities can be used. Cross Commodity Output 407 can be used to compare different commodities on a same line chart over time. Average values along with a daily break down can be included in a summary section of the displayed output.

Cross Commodity Output 407 is generated using the following algorithm(s):

y-axis (can be one or more of the following):
LBMP UNIT COST (Average):
FUTURES UNIT COST for a give contract Month and Year over time:
UNIT COST for GAS (Uses a different scale);

x-axis=TIME (days)

The Cross Commodity Output 407 can also display averages for each component over the full time period, plus a break down of pricing for each day.

Outputs 401-407 can be saved to database 112 for future use.

In addition to Modules 202-208, a Sustainability Module can also be included in the system. Sustainability Module can be used to track, measure and report on a “carbon footprint” of a building or aggregate of buildings as it relates to electric and fuel usage. [Please provide further information.]

Data from database 112 and input parameters 201 can be used by Modules 202-208 to itemize billing information for individual consumers of a particular building under analysis. For example, the system can track a list of buildings for a specific customer. The system can list all customers that are available for each building. The system can output for display bill periods for a particular customer.

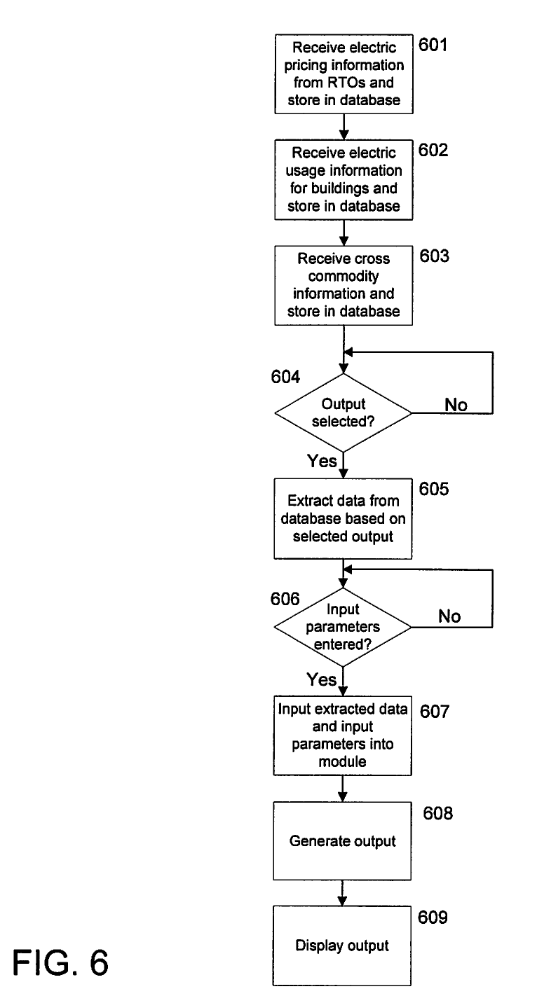

FIG. 6 is a flow chart illustrating a method for managing electric purchasing strategies according to an embodiment of the present invention. In step 601, energy management system 110 receives electric pricing information from RTOs 107-108 and stores the received pricing information in database 112. In step 602, energy management system 110 receives electric usage information for buildings 101-103 and stores the received electric usage information in database 112. In step 603, energy management system 110 receives cross commodity information and stores the received cross commodity information in database 112: if the energy management system is not performing cross commodity calculations, this step can be omitted. In step 604, energy management system 110 determines if an output (i.e. Output 401-407) is selected. If an Output 401-407 is selected, in step 605, energy management system 110 extracts data from database 112 based on the selected output. In step 606, energy management system 110 determines if input parameters are entered. If input parameters are entered, in step 607, energy management system 110 inputs extracted data and input parameters into Module 202-208 that is/are to generate the selected output. In step 608, energy management system 110 generates the output based on the output selected in step 604. In step 609, energy management system 110 displays the generated output.

As can be seen, the strategies of selecting an electric company and/or determining whether to purchase electricity in the spot market or on the futures market can be managed closely by the present invention thus realizing savings for an organization.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A system for managing electric purchasing strategies, comprising:
a processor for receiving electric pricing information, receiving electric usage information, receiving a plurality of input parameters, and generating electric purchasing strategies based on the electric pricing information, the electric usage information, and the plurality of input parameters; and
a memory for storing the electric pricing information, storing the electric usage information, storing the plurality of input parameters, and storing the electric purchasing strategies.

2. The system for managing electric purchasing strategies of claim 1, wherein the electric pricing information is electronically received from at least one Regional Transmission Organization (RTO) or Independent System Operator (ISO).

3. The system for managing electric purchasing strategies of claim 2, wherein the electric pricing information is electronically received from the at least one RTO or ISO on a periodic basis.

4. The system for managing electric purchasing strategies of claim 1, wherein the electric usage information is electronically imported from an electric company selected to supply electric power for a building.

5. The system for managing electric purchasing strategies of claim 1, wherein the electric usage information is received from an electronic power meter configured to determine electric usage information of a building.

6. The system for managing electric purchasing strategies of claim 1, wherein the electric purchasing strategies include at least one of an electric pricing strategy, an electric usage strategy, an electric cost analysis strategy, a hedge position strategy, a projection strategy, a futures pricing strategy, and a cross commodity strategy.

7. The system for managing electric purchasing strategies of claim 1, wherein the processor receives information related to at least one commodity that influences electric pricing and wherein the memory stores the information related to at least one commodity.

8. The system for managing electric purchasing strategies of claim 2, wherein the processor generates and outputs pricing information based on a cost of power for a specific RTO or block cost as a function of time.

9. The system for managing electric purchasing strategies of claim 8, wherein the pricing information reflects peak usage time, off peak usage time, or an aggregate of peak and off peak usage times.

10. The system for managing electric purchasing strategies of claim 1, wherein the processor generates and outputs interval information based on a an amount of electricity used or a size of a block of electricity purchased as a function of time.

11. The system for managing electric purchasing strategies of claim 10, wherein the interval information is based in part on least one of hedging information, overage information, aggregate information, and load factor information.

12. The system for managing electric purchasing strategies of claim 1, wherein the processor generates and outputs cost information based on an unhedged cost and an amount of electricity used, or a block cost and a block purchase size as a function of time.

13. The system for managing electric purchasing strategies of claim 12, wherein the cost information is based in part on least one of block information, unhedged information, cost information, retail adder information, line loss information, overage information, blended cost information, and usage information.

14. The system for managing electric purchasing strategies of claim 1, wherein the processor generates and outputs block information based on a total amount of electric blocks purchased for a specified period as a function of time.

15. The system for managing electric purchasing strategies of claim 14, wherein the block information is based in part on least one of a market price, a price average, a block size, a hedging factor, a usage amount, and actual purchase information.

16. The system for managing electric purchasing strategies of claim 1, wherein the processor generates and outputs budget information as set forth in Table 5A.

17. The system for managing electric purchasing strategies of claim 1, wherein the processor generates and outputs futures information based on a unit price for futures contracts for the dates specified as a function of time.

18. The system for managing electric purchasing strategies of claim 1, wherein the processor generates and outputs cross commodity information based on an average unit cost, a futures unit cost, or a unit cost for a utility other than electricity as a function of time.

19. A method for managing electric purchasing strategies, comprising:
receiving by a processor electric pricing information and storing in a memory the electric pricing information:
receiving by the processor electric usage information and storing in the memory the electric usage information;
receiving by the processor a plurality of input parameters and storing in the memory the plurality of input parameters; and
generating by the processor electric purchasing strategies based on the electric pricing information, the electric usage information, and the plurality of input parameters.

20. A system for managing electric purchasing strategies, comprising:
a processor for electronically receiving on a periodic basis electric pricing information from at least one Regional Transmission Organization (RTO) or Independent System Operator (ISO), electronically importing electric usage information from an electric company selected to supply electric power for a building, electronically receiving information related to at least one commodity that influences electric pricing, receiving a plurality of input parameters, and generating electric purchasing strategies based on the electric pricing information, the electric usage information, and the plurality of input parameters, the electric purchasing strategies including at least one of an electric pricing strategy, an electric usage strategy, an electric cost analysis strategy, a hedge position strategy, a projection strategy, a futures pricing strategy, and a cross commodity strategy; and
a memory for storing the electric pricing information, storing the electric usage information, storing the plurality of input parameters, storing the information related to at least one commodity, and storing the electric purchasing strategies.
